(19) United States
(12) Patent Application Publication
(10) Pub. No.: US 2009/0295454 A1
(43) Pub. Date: Dec. 3, 2009

(54) LOW VOLTAGE MIXER CIRCUIT

(75) Inventors: Mihai A. T. Sanduleanu, Maastricht (NL); Eduard F. Stikvoort, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/720,318

(22) PCT Filed: Nov. 24, 2005
(86) PCT No.: PCT/IB05/53888

§ 371 Date: Aug. 4, 2009

(30) Foreign Application Priority Data
Nov. 26, 2004 (EP) 04106102.9

(51) Int. Cl. G06F 7/44

(52) U.S. Cl. 327/359

(57) ABSTRACT

A mixer circuit (102) for use in radio frequency (RF) equipment is disclosed. The mixer comprises a current source (Io) and a differential amplifier (Q1, Q2) connected to the current source and having input terminals (RF+, RF−) for receiving an RF input signal and output terminals (IF+, IF−) for providing an intermediate frequency signal. A local oscillator signal (LO) is applied to a transistor (Q3) connected in parallel with the differential amplifier to adjust the current flowing in the differential amplifier such that the differential output signal contains components having frequencies at the sum and difference frequencies of the RF and local oscillator signals. Emitter degeneration resistors (R1) and a transistor Q4 for diverting part of the current to the supply improve the linearity of the mixer.

The present invention relates to mixer circuits, and relates particularly, but not exclusively, to mixer circuits adapted for low voltage applications.

Mixer circuits are important building blocks in radio frequency (RF) apparatus and combine input signals at first and second frequencies to generate output signals having components with frequency at the sum of the first and second frequencies and at the difference between the first and second frequencies.

Noise and linearity represent the main design constraints during synthesis of mixer circuits at transistor abstraction level. A further factor affecting design of mixer circuits is the requirement for the breakdown voltage of a fast bipolar or CMOS process to decrease to cope with the desired increase in transition frequency of the process. In some cases, battery operation and limited battery volume will limit the available power supply voltage.

As long as downscaling of threshold voltages in CMOS processes continues, CMOS devices can operate at lower supply voltages than equivalent bipolar devices. For bipolar devices, on the other hand, the base-emitter voltages are not downscaled for quantum-mechanical reasons, and in some modern SiGe processes, these voltages have increased. As a result, the linearity of RF building blocks worsens as supply voltages are lowered, and many existing RF building blocks will fail to operate satisfactorily.

In addition, a breakdown voltage of 2V for recently developed SiGe processes requires a drastic reduction in supply voltages

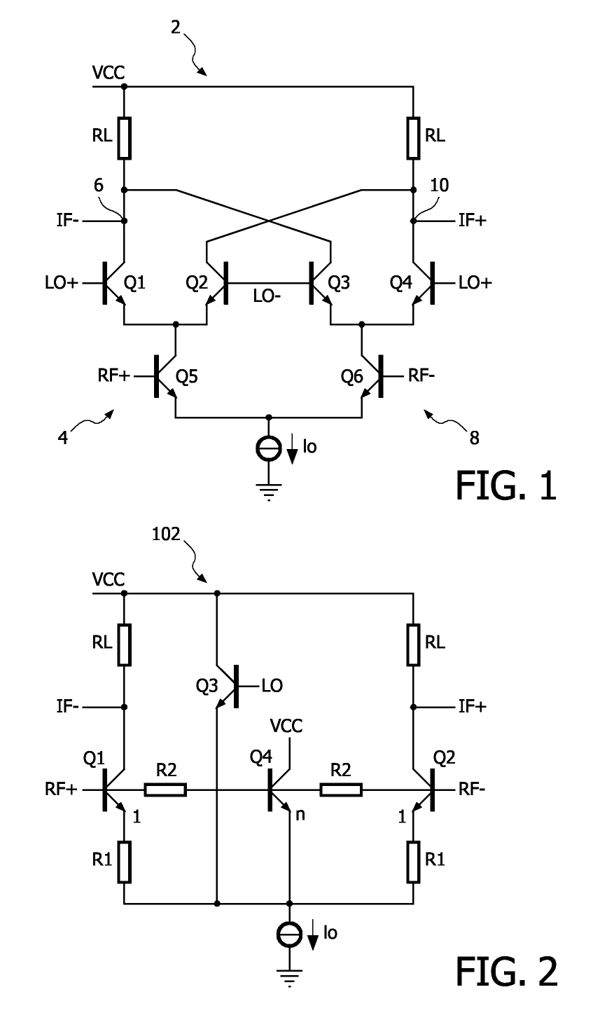

One of the commonest forms of monolithic bipolar RF mixer circuit is the double balanced Gilbert mixer, as shown in FIG. 1. The mixer 2 has a first differential amplifier stage 4 having first and second transistors Q1, Q2 across which a differential local oscillator signal is applied to adjust the amount of current flowing in load resistors RL, and an output terminal 6 at which a first output voltage is developed. The differential local oscillator signal is also applied to a second differential amplifier stage 8 having third an fourth transistors Q3, Q4, a load resistor RL and an output terminal 10 at which a second output voltage is developed. The collectors of the second and third transistors Q2, Q3 are connected to the second and first output terminals 6, 10 respectively.

The transconductance of transistors Q1, Q2, Q3 and Q4 is dependent upon the emitter current of each transistor, which is adjusted by applying a differential radio frequency (RF) signal between fifth and sixth transistors Q5, Q6, which are located in the tails of the first and second amplifier stages 4, 8 respectively. As a result, the differential voltage signal appearing across the output terminals 6, 10 has a component proportional to the product of the local oscillator and RF signals. As a result of trigonometric identities, the differential output signal appearing between output terminals 6, 10 has components having frequencies at the sum of the frequencies of the local oscillator and RF frequencies and at the difference between those frequencies. By taking the differential output voltage between output terminals 6, 10, terms other than the sum and difference frequency components are removed from the output signal.

Although the Gilbert mixer shown in FIG. 1 can provide conversion gain, requires very low power to drive the local oscillator port, provides excellent isolation between the signal ports, and has no component of the local oscillator signal in the output spectrum, it suffers from a number of disadvantages if operation at low supply voltages is desired. In particular, at low supply voltage applications, stacking of transistors as shown in the mixer of FIG. 1 makes good working operation doubtful. Also, the RF input port is not matched, and therefore presents a high impedance to the signal generator. In addition, the signal handling capacity is limited to less than the threshold voltage but is not dependent upon the threshold current.

Preferred embodiments of the present invention seek to provide a mixer circuit which is suitable for implementation by bipolar components and retains its linearity at low supply voltages.

According to the present invention, there is provided a mixer circuit comprising:
a current source;
a first differential amplifier connected to said current source and having at least one input terminal for receiving a respective first input signal, at least one output terminal for providing a respective output signal, and a respective first impedance connected to at least one said output terminal such that the current flowing in each said first impedance is dependent upon said first input signal;
a current adjusting portion connected in parallel with at least part of said first differential amplifier and having at least one first transistor having a respective second input terminal for receiving a second input signal such that application of a respective said first input signal to the or each said first input terminal, and a respective said second input signal to the or each said second input terminal generates a respective output signal at the or each said output terminal including components of frequency at the sum of the frequencies of the first and second input signals, and at the difference of the frequencies of said first and second input signals; and
linearising means for reducing the distortion of the respective said output signal corresponding to the or each said first input signal.

By providing a current adjustment portion connected in parallel with at least part of the first differential amplifier together with linearising means for reducing distortion of the respective output signal corresponding to the or each first input signal, this provides the advantage of avoiding stacking of transistors necessary in the Gilbert mixer shown in FIG. 1, as a result of which the mixer also operates satisfactorily at lower supply voltages than the prior art. In particular, by providing a transistor in parallel with the first differential amplifier, the differential amplifier current can be adjusted by the second input signal without the necessity of the large voltage drop of the Gilbert cell of FIG. 1.

The linearising means may comprise at least one second transistor connected in parallel with at least part of said first differential amplifier and having a respective third input terminal for receiving at least part of a said first input signal.

By providing at least one second transistor connected in parallel with at least part of the first differential amplifier and having a respective third input terminal for receiving at least part of a said first input signal, this provides the advantage that linearity of the mixer may be improved in a relatively simple manner and which operates at low supply voltages.

The first differential amplifier may include a pair of third transistors, each of which includes a respective said first input terminal.

The transistors may be bipolar junction transistors and said linearising means may comprise a respective second impedance connected to the emitter of each said bipolar junction transistor.

The or each said first input terminal may be connected to a respective said third input terminal by means of respective third impedances.

The first differential amplifier may have a pair of said first input terminals across which a said first input signal may be applied, and a pair of said output terminals across which a said output signal may be provided.

The mixer may further comprise a second differential amplifier connected to said current source and having at least one input terminal for receiving a respective said first input signal, at least one output terminal for providing a respective output signal, and a respective fourth impedance connected to at least one said output terminal such that the current flowing in each said fourth impedance is dependent upon said first input signal.

This provides the advantage of providing a double balanced mixer in which an output signal taken between an output terminal of the first differential amplifier and an output terminal of the second differential amplifier has fewer unwanted components (i.e. components at frequencies other than the sum of the frequencies of the first and second input signals and the difference between those frequencies) than in the case of a single balanced mixer.

The mixer may further comprise a further current adjusting portion connected in parallel with at least part of said second differential amplifier and comprising at least one fourth transistor having a second input terminal for receiving a second input signal such that a second input signal is applied in use across the second input terminals of said first and fourth transistors.

Preferred embodiments of the invention will now be described, by way of example only and not in any limitative sense, with reference to the accompanying drawings, in which:

FIG. 1 is a circuit diagram of a prior art mixer circuit;

FIG. 2 is a circuit diagram of a first embodiment of the present invention;

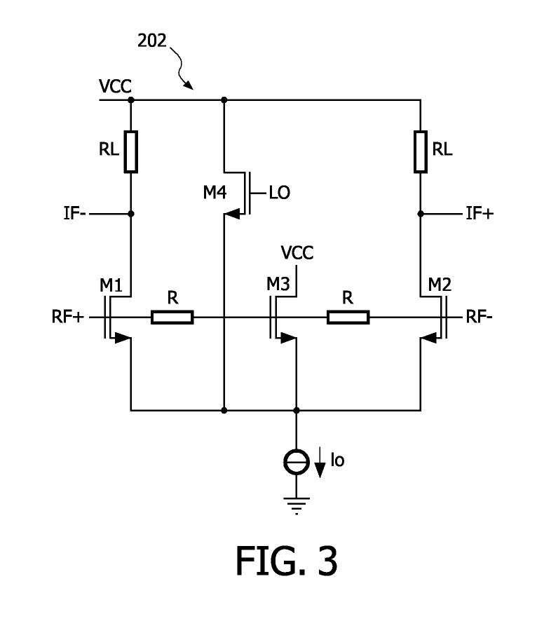

FIG. 3 is a circuit diagram of a second embodiment of the present invention;

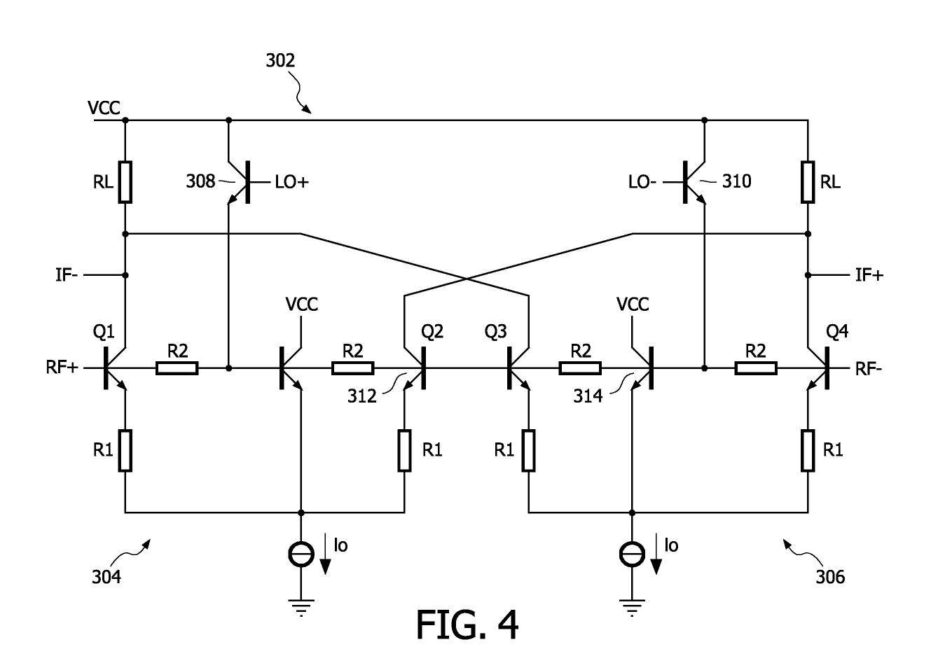

FIG. 4 is a circuit diagram of a third embodiment of the present invention;

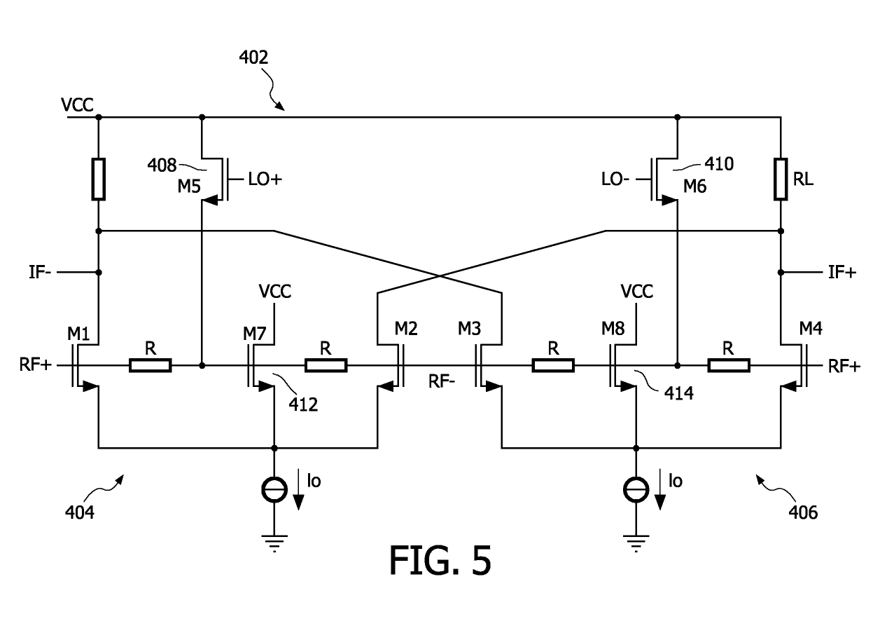

FIG. 5 is a circuit diagram of a fourth embodiment of the present invention;

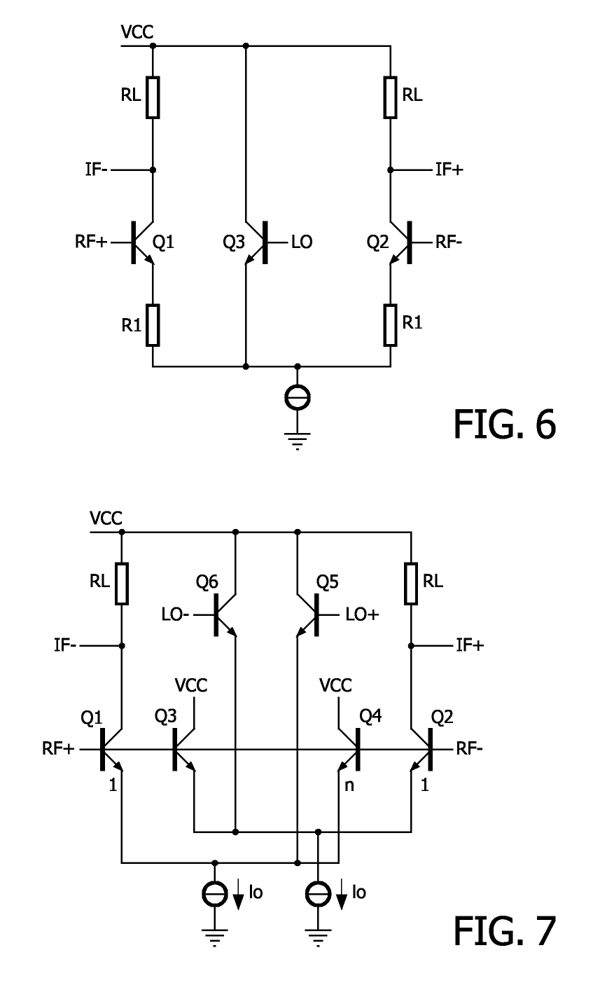

FIG. 6 is a circuit diagram of a fifth embodiment of the present invention; and

FIG. 7 is a circuit diagram of a sixth embodiment of the present invention.

Referring firstly to FIG. 2, a single balanced radio frequency (RF) mixer 102 of a first embodiment of the present invention comprises a differential amplifier having bipolar transistors Q1, Q2 to the bases of which an RF signal RF+, RF− is differentially applied. The collectors of transistors Q1, Q2 are connected to respective output resistors RL via respective output terminals IF−, IF+, and the emitters of transistors Q1, Q2 are provided with degeneration resistors R1 to improve the linearity of the mixer.

A current source Io is connected to the differential amplifier for providing current through emitter resistors R1 and collector resistors RL, and the linearity of the mixer is further improved by providing a transistor Q4 in parallel with the differential amplifier such that the current source lo biases the transistors Q1, Q2 and Q4 at a current necessary for broadband operation and low distortion. For this to occur, the emitter area factor n of transistor Q4 should be larger than 2. The linearization of the transconductance of the differential transistor pair Q1, Q2 is achieved by means of the transistor Q4 conveying nonlinear terms and part of the dc current Io to the supply.

The input impedance at the RF port and the linearity are almost decoupled and can therefore be optimised separately. The bases of transistors Q1, Q2 are connected to the base of transistor Q4 via respective input resistors R2. The resistors R2 create a differential input impedance of 2R2 matched with the output impedance of the BALUN or low noise amplifier (LNA) (not shown) supplying the RF signal. This ensures optimum power transfer between the LNA or BALUN and the mixer.

A transistor Q3 is connected in parallel with the differential amplifier, such that application of a local oscillator signal LO of up to 300 mV peak to peak amplitude to the base of transistor Q3 adjusts the current flowing in the emitters of transistors Q1, Q2. Because of the dependence of the transconductance of transistors Q1, Q2 on their respective emitter currents, the voltage signal at each of the output terminals IF−, IF+has a component dependent upon the product of the RF and local oscillator signals with a gain scaling factor.

It will be appreciated by persons skilled in the art that as a result of trigonometric identities, the signals at output terminals IF− and IF+ have components having frequencies at the frequency of the RF signal, the frequency of the local oscillator signal, and the frequencies of the sum and difference of the frequencies of those signals. By applying the signal across the output signals to a differential amplifier (not shown) the component of the signal at the local oscillator frequency is removed, as a result of which the differential output signal has components at the RF frequency, at the sum of the local oscillator and RF frequencies, and at the difference between the local oscillator and RF frequencies.

In order to improve the linear behaviour of the mixer, a further transistor Q4 has a base connected to the bases of transistors Q1, Q2 by means of respective input resistors R2, R2. The emitter area factor of transistor Q4 is at least two for correct operation, and linearization of the mixer 102 is improved by means of transistor Q4 conveying non-linear terms to the supply, as well as causing part of the DC current to be dumped to the positive supply VCC.

The input impedance at the bases of transistors Q1, Q2 and the linearity of the mixer 102 are almost decoupled and can therefore be optimised separately. The series input resistors R2, R2 create a differential input impedance of 2R2 matched with the output impedance of a BALUN or low noise amplifier (not shown) with which the mixer 102 operates. This ensures optimum power transfer between the low noise amplifier and the mixer 102.

Referring now to FIG. 3, in which parts common to the embodiment of FIG. 2 are denoted by like reference numerals but increased by 100, a MOS variant 202 of the mixer of FIG. 2 is shown. Source degeneration resistors (corresponding to the emitter degeneration resistors R1 of FIG. 2) are no longer required for linearity.

The mixers of both FIGS. 2 and 3 do not achieve linearity at the cost of voltage room, so both arrangements can operate at low supply voltages.

In order to achieve larger conversion gain than the mixer of FIG. 2 without local oscillator or RF feedthrough, a double balanced mixer 302 is used as shown in FIG. 4. The mixer 302 of FIG. 4 has a first differential amplifier 304 having transistors Q1, Q2, and a second differential amplifier 306 having transistors Q3, Q4. The bases of transistors Q2, Q3 are connected together and are connected to the bases of transistors Q1, Q4 respectively via input resistors R2. The RF signal is applied differentially to the bases of transistors Q1, Q4 respectively, and the local oscillator signal is applied differentially to the bases of transistors 308, 310 connected between the positive supply rail VCC and the bases of respective linearising transistors 312, 314 connected in parallel with the respective differential amplifiers 304, 306.

The collectors of the transistors Q2, Q3 are connected to the collectors of transistors Q4, Q1 respectively, and a balanced output signal is provided across output terminals IF−, IF+. The differential output signal does not have components at the RF and local oscillator frequencies, and the conversion gain is a factor 2 larger for the double balanced mixer 302 of FIG. 4 than for the corresponding single balanced mixer of FIG. 2.

Similarly, referring to FIG. 5, a MOS version 402 of the double balanced mixer is shown, in which parts common to the embodiment of FIG. 4 are denoted by like reference numerals but increased by 100. Again, the source degeneration resistors corresponding to resistors R1 of FIG. 4 are no longer required.

It will be appreciated by persons skilled in the art that the above embodiments have been described by way of example only and not in any limitative sense, and that various alterations and modifications are possible without departure from the scope of the invention as defined by the appended claims. For example, various alternatives to the linear gain stage shown in FIG. 2 can be applied, although less linearity will be achieved. For example, FIG. 6 shows a further embodiment of the invention, in which linearization is achieved by means of resistors R1 causing emitter degeneration, and FIG. 7 uses a “1 to n” stage as an RF linear stage. It also be appreciated by persons skilled in the art that double balanced versions of the embodiments of FIGS. 6 and 7 can also be provided.

1. A mixer circuit comprising: a current source; a first differential amplifier connected to said current source and having at least one input terminal for receiving a respective first input signal, at least one output terminal for providing a respective output signal, and a respective first impedance connected to at least one said output terminal such that the current flowing in each said first impedance is dependent upon said first input signal; a current adjusting portion connected in parallel with at least part of said first differential amplifier and having at least one first transistor having a respective second input terminal for receiving a second input signal such that application of a respective said first input signal to the or each said first input terminal, and a respective said second input signal to the or each said second input terminal generates a respective output signal at the or each said output terminal including components of frequency at the sum of the frequencies of the first and second input signals, and at the difference of the frequencies of said first and second input signals; and linearising means for reducing the distortion of the respective said output signal corresponding to the or each said first input signal.

2. A circuit according to claim 1, wherein the linearising means comprises at least one second transistor connected in parallel with said first differential amplifier and having a respective third input terminal for receiving at least part of a said first input signal.

3. A circuit according to claim 2, wherein the or each said first input terminal is connected to a respective said third input terminal by means of respective third impedances.

4. A circuit according to claim 1, wherein the first differential amplifier includes a pair of third transistors, each of which includes a respective said first input terminal.

5. A circuit according to claim 4, wherein the transistors are bipolar junction transistors and said linearising means comprises a respective second impedance connected to the emitter of each said bipolar junction transistor.

6. A circuit according to claim 1, wherein the first differential amplifier has a pair of said first input terminals across which a said first input signal may be applied, and a pair of said output terminals across which a said output signal may be provided.

7. A circuit according to claim 1, further comprising a second differential amplifier connected to said current source and having at least one input terminal for receiving a respective said first input signal, at least one output terminal for providing a respective output signal, and a respective fourth impedance connected to at least one said output terminal such that the current flowing in each said fourth impedance is dependent upon said first input signal.

8. A circuit according to claim 7, further comprising a further current adjusting portion connected in parallel with at least part of said second differential amplifier and comprising at least one fourth transistor having a second input terminal for receiving a second input signal such that a second input signal is applied in use across the second input terminals of said first and fourth transistors.
